(19) United States
(12) Patent Application Publication
(10) Pub. No.: US 2009/0100953 A1
(43) Pub. Date: Apr. 23, 2009

(54) SPEED REDUCTION GEARING MECHANISM FOR PISTON OF AIR COMPRESSOR

(76) Inventor: CHI-MING CHEN, Hsintien City (TW)

Correspondence Address: LEONG C LEI, PMB # 1008, 1867 YGNACIO VALLEY ROAD, WALNUT CREEK, CA, 94598, US

(21) Appl. No.: 11/875,967

(22) Filed: Oct. 22, 2007

(51) Int. Cl. F16H 35/00

(52) U.S. Cl. 74/390

(57) ABSTRACT

A speed reduction gearing mechanism is adapted to couple a piston/piston rod of a cylinder of an air compressor to a motor spindle to ensure stability and smoothness of operation of the air compressor. The speed reduction gearing mechanism includes a reduction gear that is of a composite structure composed of an internal metallic portion that ensures mechanical strength and an extern ring-like toothed portion of plastic injection molding enclosing the internal portion. The reduction gear functions to convert the rotation of the motor spindle into reciprocation of the piston/piston rod with increased torque applied to the piston rod and effectively enhanced compression ratio between the piston and the cylinder and, due to the composite enclosing structre of the reduction gear, also to ensure more stable operation of the air compressor with reduced shock/vibration and reduced noise to thereby enhance the performance and efficiency of the air compressor.

### BACKGROUND OF THE INVENTION

(a) Technical Field of the Invention

The present invention relates to an air compressor, and in particular to a speed reduction gearing mechanism for driving a piston within a cylinder of the air compressor.

(b) Description of the Prior Art

A motor-driving air compressor, which can be a small- or medium-sized air compressor or a vehicle-carrying air compressor, is constructed by coupling a piston rod to a motor spindle with an eccentric block. In high speed rotation of the motor, the eccentric block is rotated, which in turn drives reciprocal movement of the piston rod due to the rotary and eccentric arrangement. The piston rod then reciprocally moves a piston within a cylinder to thereby compress air drawn into the cylinder.

Such a conventional structure suffers two drawbacks:

(1) Since in the conventional air compressor systems, the motor has a very high rotational speed, such a high rotational speed does not match the reciprocation speed of the piston and the piston rod and finer since the conventional air compressor system is not equipped with cooling means, when the motor is put in high speed rotation, excessively high temperature is induced in the cylinder, which makes the conventional air compression system not suitable for high power consumption operation of gas compression and further makes it impossible for the conventional air compressor system to continuously operate. In other words, the conventional air compressor system can only be operated in an intermittent manner, wherein the system must shut down after a period of operation and then be started again for next period of operation. Such a tedious process is repeated to ensure safe operation of the air compressor.

(2) Due to the high rotational speed of the motor of the conventional air compressor system, together with the coupling between the piston rod and the motor spindle being effected by an eccentric block, when the motor is put into operation, a centrifugal force is induced on the eccentric block, which causes significant vibration and noise and thus makes the operation of the air compressor instable, leading to reduced lifespan and poor performance.

Thus, it is desired to provide a reduction gearing mechanism for an air compressor to overcome the drawbacks of excessive rotational speed and insufficiency of torque and also to provide a composite structure of reduction gearing to ensure smoother operation of the air compressor.

### SUMMARY OF THE INVENTION

The primary purpose of the present invention is to provide a speed reduction gearing mechanism for a piston of an air compressor, and particularly, a speed reduction gearing mechanism of an air compressor piston that enhances smooth and stable operation of the air compressor, wherein a reduction gear is made of a composite structure that comprises an external plastic molding enclosing a metallic internal portion, which not only converts rotation of a motor into reciprocal movement of the piston with enhanced transmission of torque applied to the piston rod and effectively improving compression ratio between the piston and the cylinder, but also makes the operation more stable with reduced vibration/shock and noise to consequently enhance operation efficiency and performance of the air compressor.

The speed reduction gearing mechanism in accordance with the present invention realizes two goals. (1) With the arrangement of the reduction gear, the rotational speed applied from the motor to the piston rod is effectively reduced so as to raise the torque applied to the piston rod to ensure the optimum arrangement among the piston, the piston rod, and the motor. (2) With a composite, enclosing configuration of the reduction gear, the above discussed improvement of performance can be realized in a more stable and shock- and noise-reduced manner.

In summary, the present invention relates to an air compressor system that is driven by a motor and that comprise a cylinder in which a piston is reciprocally moved by a piston rod that is coupled to the motor. More particularly, the present invention provides a technique solution that reduces the high speed output of the motor and realizes simultaneously speed change and torque increase. In addition, the reduction gear of the present invention is of a structure that provides an air compressor that is driven by a motor with more stable operability and reduction of vibration/shock and noise of operation.

The present invention provides a speed reduction gearing mechanism that comprises a reduction gear having a central rotation shaft located below a motor spindle and mating a driving gear mounted to the motor spindle to be driven thereby. The reduction gear forms a shaft hole that is eccentric with respect to the central shaft of the reduction gear for rotatably coupling a piston by means bearing and shaft so that due to the rotary and eccentric arrangement, when the motor spindle transmits high speed rotation to the reduction gear, the reduction gear effectively reduces the rotational speed, while driving the piston rod to cause a piston to perform reciprocal movement within a cylinder thereby compressing air drawn into the cylinder.

The reduction gear in accordance with the present invention is of a composite structure having an enclosing integrated configuration. In other words, the reduction gear is composed of two portions of different materials and in a preferred embodiment, the reduction gear comprises an external ring-like toothed portion of plastic injection molding enclosing and integrally fixed with an internal metallic portion to provide a feature of being externally soft and internally rigid. In this way, when the reduction gear is put in engagement with the driving gear of the motor spindle, the reduction gear provides an engagement of “sof” contact with the driving gear and preserves the desired rigidity for the operation of gearing. Thus, noise of operation caused by engagement between metallic teeth of two gears is eliminated and the vibration/shock occurring in the process of operation is also reduced to thereby ensure smoother and more stable operation of the air compressor system.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front view of an air compressor system comprising a cylinder containing a piston in which a speed reduction gearing mechanism in accordance with the present invention is embodied;

FIG. 2 is a side elevational view, partially sectioned, of the air compressor system shown in FIG. 1;

FIG. 3 is a plan view showing engagement between a reduction gear of the speed reduction gearing mechanism of the present invention and a motor of the air compressor system; and

FIG. 4 is a cross-sectional view of the reduction gear of the speed reduction gearing mechanism of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

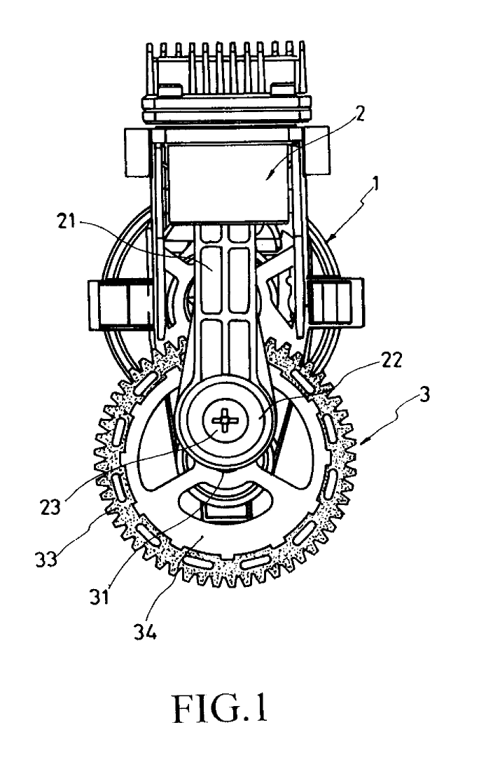

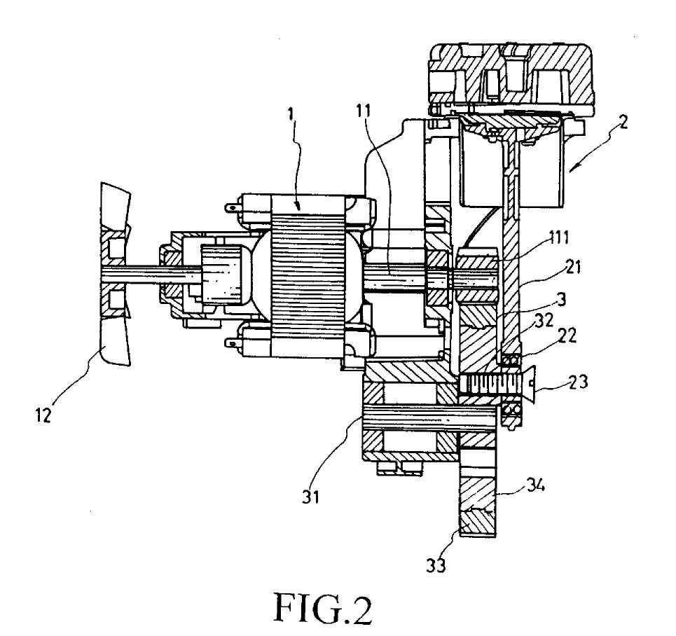

With reference to the drawings and in particular to FIGS. 1 and 2, a speed reduction gearing mechanism constructed in accordance with the present invention is provided for a piston of an air compressor. The reduction gearing mechanism of the present invention comprises a motor (1), a cylinder (2), and a reduction gear (3). The motor (1) has a spindle (11) having a rearward-extending section to which a heat dissipation fan (12) is mounted. The heat dissipation fan (12) is driven by the rotation of the motor spindle (11) to effectively remove heat that is essentially generated by the operation of the motor (1) and the cylinder (2). The motor spindle (11) has a frontward-extending section to which a driving gear (111) made of metal is mounted and engageable with the reduction gear (3) that is rotatably arranged below the motor (1).

As shown in FIG. 2, the cylinder (2) comprises a piston rod (21) that is rotatably coupled to the reduction gear (3) by means of a bearing (22) and a shaft (23) that extends and is rotatably received in a shaft hole (32) defined in the reduction gear (3). The shaft hole (32) is formed in the reduction gear (3) and is eccentric with respect to a central shaft (31) of the reduction gear (3) so that an eccentricity distance is present between the central shaft (31) and the shaft hole (32) to cause vertical reciprocal movement of the piston rod (21) at the time the reduction gear (3) is put in rotation.

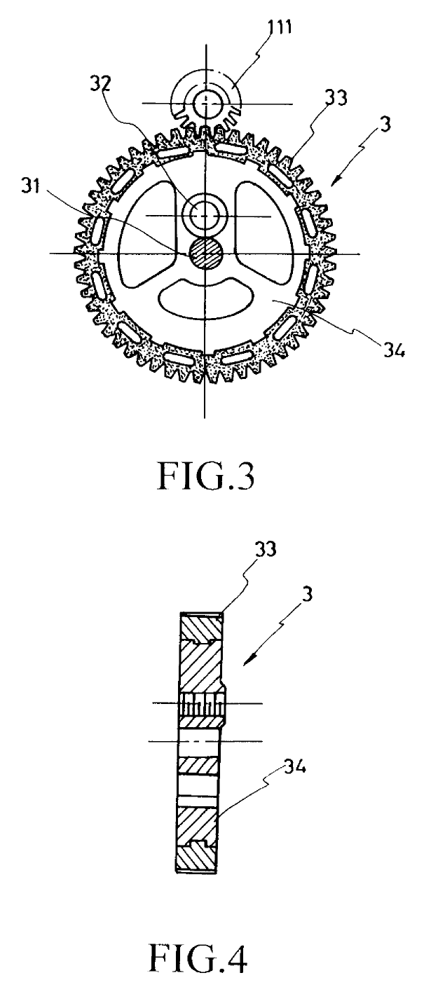

Also referring to FIG. 3, the reduction gear (3) is rotatably fixed below the motor spindle (11) by means of the central shaft (31) to mate and engage the motor driving gear (111). The reduction gear (3) forms the shaft hole (32) in a manner of being eccentric with respect to the central shaft (31) thereof and the shaft hole (32) serves to rotatably couple the piston rod (21) through the bearing (22) and the shaft (23). With the eccentricity distance, when the driving gear (111) transmits high-speed rotational power to the reduction gear (3), effective reduction of rotational speed can be realized, which protects the while air compressor system from over-heating caused by excessive operation speed.

Also referring to FIGS. 3 and 4, the reduction gear (3) is made of a composite structure, of which a practical embodiment comprises a plastic injection molding integrally enclosing an internally located metallic portion (34), wherein an external ring-like toothed portion (33) is of a plastic injection-molded structure, which encloses the internal metallic portion (34) to complete the composite structure of the reduction gear (3), which exhibits a feature of being externally soft and internally rigid. Thus, when the reduction gear (3) is put in engagement with the motor driving gear (111), a “soft” contact of engagement is realized, while sufficient rigidity is preserved for the proper operation of the gear. In this way, noise caused by the gearing engagement and operation can be effectively reduced and further shock caused by the operation can also be reduced so that the whole air compressor system can be operated in a more smooth and stable manner.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A speed reduction gearing mechanism for an air compressor piston comprising a motor, a cylinder, and a reduction gear, wherein the reduction gear is rotatably fixed below a spindle of the motor and engageable with a driving gear of the motor, the reduction gear forming a shaft hole that is eccentric with respect to a central shaft of the reduction gear for rotatable coupling with a piston rod by means of bearing and shaft; and wherein the reduction gear has a composite structure comprising an internally-located metallic portion that is integrated with and enclosed by an external plastic injection-molding that has a ring-like toothed configuration.
